(19) United States
(12) Patent Application Publication
(10) Pub. No.: US 2009/0140655 A1
(43) Pub. Date: Jun. 4, 2009

(54) SIMPLE PROTECTION CIRCUIT AND ADAPTIVE FREQUENCY SWEEPING METHOD FOR CCFL INVERTER

(75) Inventors: Junming Zhang, Hangzhou (CN); Yuancheng Ren, Hangzhou (CN); Kaiwei Yao, Santa Clara, CA (US); Eric Yang, Saratoga, CA (US)

Correspondence Address: PERKINS COIE LLP;PATENT-SEA, P.O. BOX 1247, SEATTLE, WA, 98111-1247, US

(73) Assignee: Monolithic Power Systems, Inc., San Jose, CA (US)

(21) Appl. No.: 12/166,140

(22) Filed: Jul. 1, 2008

(30) Foreign Application Priority Data
Nov. 29, 2007 (CN) 200710193990.5

(51) Int. Cl. H05B 37/02

(52) U.S. Cl. 315/121

(57) ABSTRACT

A CCFL inverter circuit integrates a feedback circuit and protection circuit together. For both in-phase and out-of-phase applications, sensed lamp voltages can be used for open lamp and short lamp detection and sensed currents can be used for open lamp detection. The driving circuit adjusts the open lamp frequency by using a duty cycle control signal so that the driving circuit can always achieve the desired lamp voltage gain.

### CROSS-REFERENCE TO RELATED APPLICATION

The present application claims the benefit of previously filed Chinese Patent Application No. 200710193990.5 filed on Nov. 29, 2007 under 35 U.S.C. § 119.

### TECHNICAL FIELD

The present invention relates to the driving of one or more fluorescent lamps, and more particularly, to an open lamp and short lamp protection circuit and adaptive frequency sweeping method for a cold cathode fluorescent lamp (CCFL).

### BACKGROUND

Lamp current regulation at normal operation and lamp voltage regulation at open lamp condition is a function that is implemented by a CCFL inverter. Furthermore, the CCFL inverter should implement short circuit protection and open lamp voltage protection.

Typically, the winding current (or lamp current) is sensed for open lamp protection and lamp current feedback. The lamp voltage may also be sensed for short circuit protection and lamp voltage regulation during an open lamp condition. Generally, the feedback circuit and the protection circuit cannot be integrated together due to their differing requirements. For example, the lamp voltage feedback needs the maximum value of the sensed lamp voltage, and the short circuit protection circuit needs the minimum value of the sensed lamp voltage for proper detection. Therefore, four separate sets of circuits for the feedback and protection circuit are required. This requires significant external circuitry and makes for a complex circuit structure. Furthermore, the circuits are even more complex for out-of-phase applications, which are popular in current CCFL inverter systems.

A CCFL exhibits large impedance if current is not applied and smaller impedance once the lamp is ignited. Therefore, during startup period or open lamp condition, the lamp voltage should be regulated to a high value to ignite the lamp. Due to inherent characteristics of the series-parallel resonance of the circuit, the switching frequency at that time should be set to a higher value than during normal operation. In a conventional CCFL inverter, the frequency hop method is usually used. Some controllers provide separate pins to set the normal operation frequency and open lamp frequency respectively. Other controllers simply set the open lamp frequency to a certain ratio of the normal operation frequency internally. Some controllers use external circuitry to implement this function. These methods are usually complex or require an extra pin for the controller. Though the internal frequency hop method is simple, it is not flexible for varying loads. At certain load conditions, it may cause instability of the CCFL inverter.

### BRIEF DESCRIPTION OF THE DRAWINGS

FIG. 1 illustrates a waveform of the sensed lamp voltage signal LV with and without DC bias.

FIG. 2 is a schematic drawing of the LV signal detecting circuit for a 4-lamp in-phase application in accordance with the present invention.

FIG. 3 illustrates a waveform of the sensed voltage signal LV with one, two or three lamps open with the LV signal detecting circuit in FIG. 2.

FIG. 4 illustrates a waveform of the sensed voltage signal LV with one, two or three lamps short with the LV signal detecting circuit in FIG. 2.

FIG. 5(a) is a schematic diagram of a short circuit protection circuit.

FIG. 5(b) illustrates a waveform of the output of the short circuit protection circuit of FIG. 5(a).

FIG. 6 is a schematic diagram of the LVP and LVN signal detecting circuit for a 4-lamp out-of-phase application in accordance with the present invention.

FIG. 7 is a schematic diagram of the LI signal detecting OR gate circuit for a 4-lamp in-phase application in accordance with the present invention.

FIG. 8 is a schematic diagram of the LI signal detecting AND gate circuit for a 4-lamp in-phase application in accordance with the present invention.

FIG. 9 illustrates a waveform of the sensed current signal LI with one, two or three lamps open with the LI signal detecting circuit in FIG. 8.

FIG. 10a is a schematic diagram of an open lamp protection circuit.

FIG. 10b illustrates a waveform of the output of the open lamp protection circuit of FIG. 10a.

FIG. 11 is a schematic diagram of the LIP and LIN signal detecting circuit for a 4-lamp out-of-phase application in accordance with the present invention.

FIG. 12 is a schematic diagram of one of the implementations of the lamp current regulation and open lamp protection circuit in accordance with the present invention.

FIG. 13 is a schematic diagram of one of the implementations of the lamp voltage regulation and short circuit protection circuit in accordance with the present invention.

FIG. 14 is the gain curve of a CCFL inverter.

FIG. 15 is the open lamp gain curves with different parasitic parameters.

FIG. 16 is the startup waveform with frequency control by COMP in accordance with the present invention.

FIG. 17 is a schematic diagram of the adaptive frequency sweeping circuit in accordance with the present invention.

### DETAILED DESCRIPTION

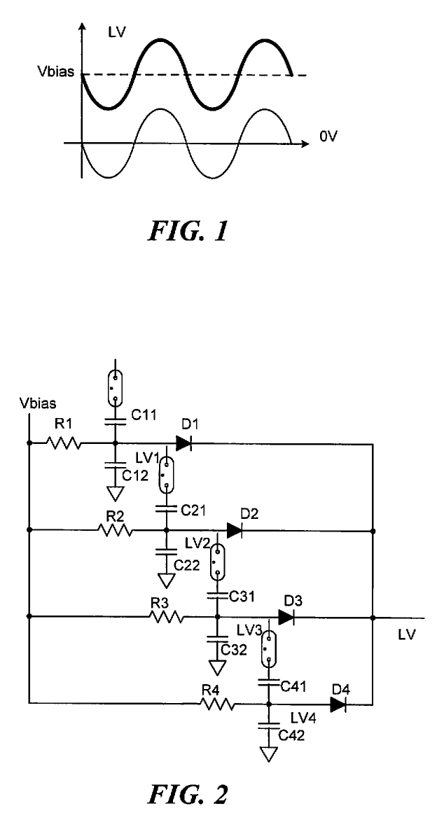

In a typical prior art circuit, only a half cycle of the lamp voltage can be used for sensing. In order to combine the feedback circuit and protection circuit, a DC bias voltage is added to the sensed lamp voltage LV. See FIG. 1. The positive half cycle is used for open lamp voltage regulation with an OR logic circuit. The negative half cycle is used for short circuit protection.

A lamp voltage (LV) signal detecting circuit according to one aspect of the present invention is shown in FIG. 2. A 4-lamp in-phase application is used as an example to describe the detailed concept. LV1, LV2, LV3 and LV4 are the sensed lamp voltages, which are all in phase. Four diodes are needed to form an OR logic gate. In general, N diodes are needed for an N-lamp application.

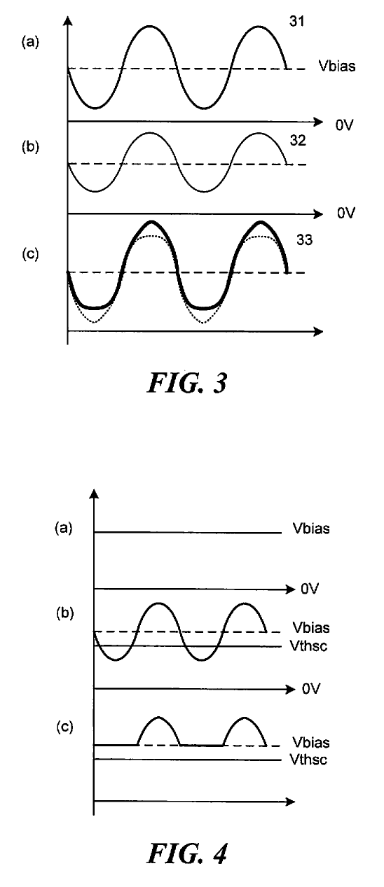

The sensed signal LV typically follows the largest voltage value of all the sensed lamp voltages. As shown in FIG. 3a and FIG. 3b, the lamp voltage will increase when the lamp is open even without increasing the switching frequency due to increased Q of the resonant circuit. In the case of one, two or three lamps open, the sensed signal LV follows the solid line shown in FIG. 3c. When it is higher than Vbias, LV follows the open lamp voltage. When it is lower than Vbias, LV follows the normal operation waveforms (FIG. 3b). Therefore, the peak value of the sensed signal LV can be used to regulate the open lamp voltage.

When all the lamps are shorted, the sensed signal LV is equal to the bias voltage as shown in FIG. 4a. The valley of the waveform disappears. In the case of one, two or three lamps being shorted, the sensed signal changes to the waveform with solid line shown in FIG. 4c. When the voltage is higher than Vbias, LV follows the normal operation waveform. When the voltage is lower than Vbias, LV follows the shorted lamp voltage, which is equal to Vbias. Therefore, the valley value can be used for lamp short circuit protection.

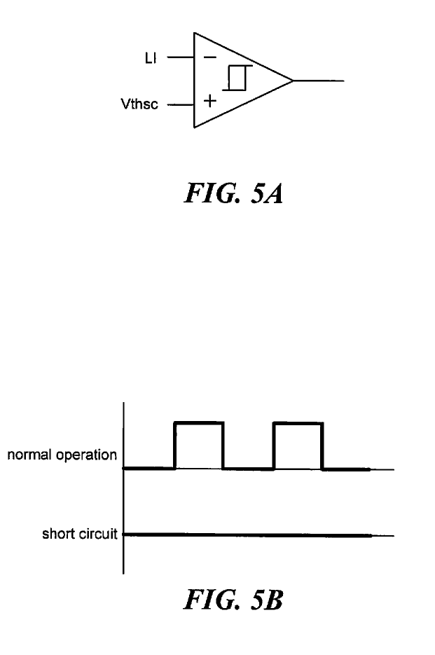

The sensed signal LV is compared to a threshold Vthsc, which is in one embodiment is slightly less than Vbias. This is performed by a comparator of FIG. 5a. When the waveforms of FIG. 4b are input into the comparator of FIG. 5a, the comparator will output a pulsed waveform (top waveform of FIG. 5b). The pulses correspond to where the sensed voltage LV is greater than the threshold Vthsc. It can be seen that in an alternative embodiment, the comparator can be configured to output a pulse where LV is less than Vthsc. The important element is that where LV crosses Vthsc, a signal is provided.

As shown in the upper waveform of FIG. 5b, in normal operation, the comparator outputs a pulsed signal. When the pulse is missing, as in the lower waveform of FIG. 5b, this is indicative of a short circuit. Under these conditions, short circuit protection can be triggered.

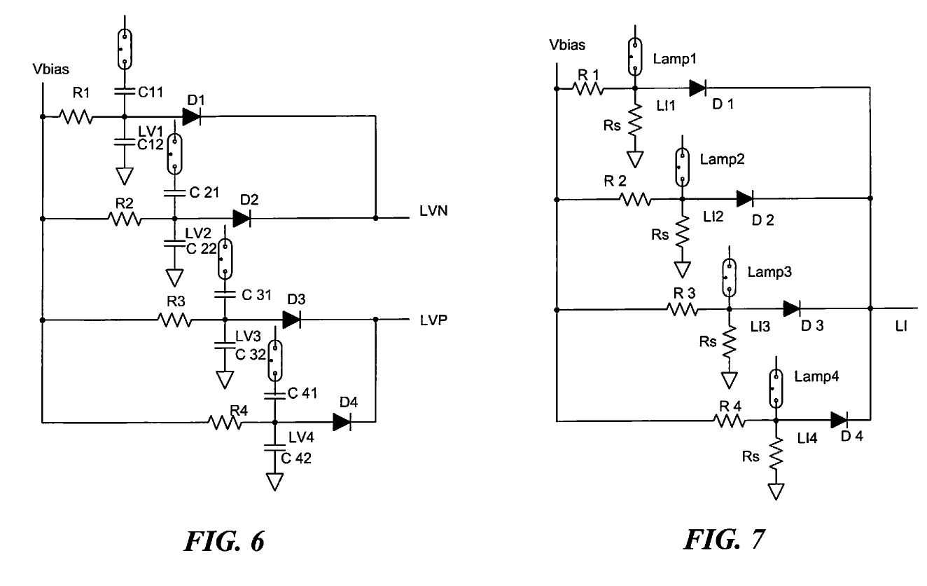

For out-of-phase applications, the present invention is also applicable. FIG. 6 shows a 4 lamp out-of-phase application according to another embodiment of the present invention. The lamps are divided into two groups, i.e. an in-phase group and an out-of-phase group. For the N-lamp case, N/2 diodes are needed to form an OR logic gate for each group respectively. There are two sensed signals LVP and LVN. The peak value of LVP and LVN is used to regulate the open lamp voltage. LVP and LVN are compared to a threshold by two separate comparators. As above, short circuit protection can be easily detected if the output pulse of any comparator is missing.

Lamp current is another critical parameter for a CCFL controller. Also, lamp current is used for open lamp protection, which is more reliable in practical applications. Conventional CCFL inverters usually use a separate feedback circuit and open lamp protection. The reason for the complexity of the conventional circuit is that only a half cycle or the average of the lamp current is used for feedback.

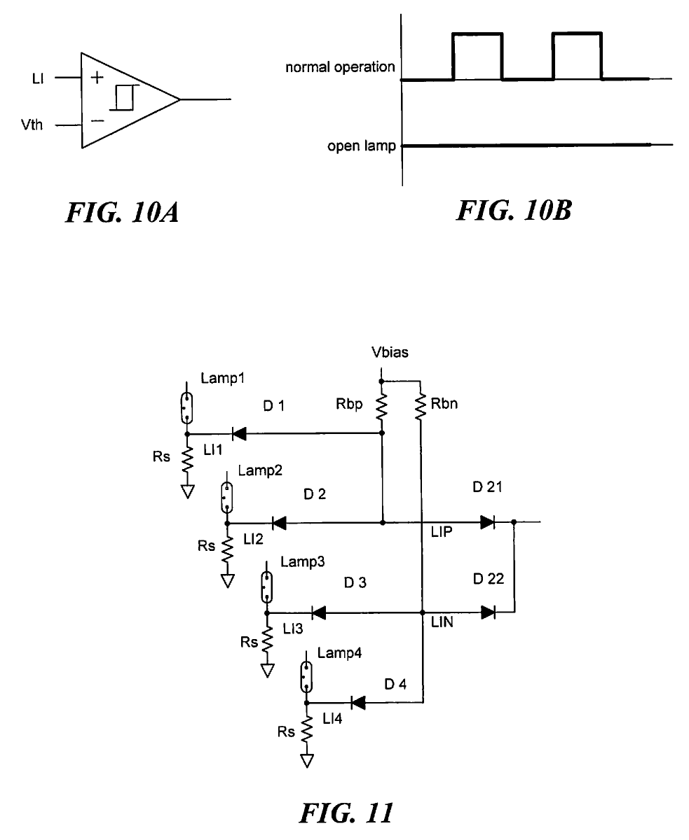

To combine the feedback circuit and open lamp protection circuit, the solution of using an OR gate and DC bias as described above can also be adopted. A 4-lamp in-phase application is shown in FIG. 7. The operation principle is the same as described above, but the lamp current signal is used instead of the lamp voltage. Specifically, the open lamp can be detected by comparing the LI signal to a threshold Vth using a comparator (FIG. 10). The peak value or RMS value can be used for lamp current regulation.

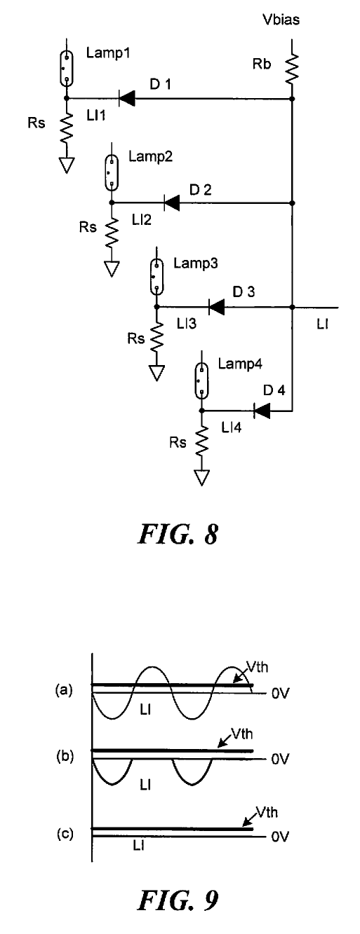

Another method to combine the feedback and open lamp protection circuit is using an AND gate. In this method, no DC bias voltage is introduced into the lamp current signal. A 4-lamp in-phase application shown in FIG. 8 is used as an example. The sensed LI signal follows the smallest current signal of all the sensed current signals.

In normal operation, the sensed LI signal is an AC signal. The RMS value can be used to regulate the lamp current, which is usually required in practical application. The DC component of the sensed LI signal is almost equal to zero (usually, the pull up resistor Rb is much larger than the current sense resistor Rs as shown in FIG. 8). If one, two or three lamps are open, the positive half cycle of the sensed signal LI will be missing as shown in FIG. 9. Therefore, the positive half cycle can be used for open lamp protection. The sensed signal LI is compared to a relatively small positive threshold. In open lamp condition, the pulse is missing as shown in the lower waveform of FIG. 10.

For out-of-phase applications, the present invention may also be used. The lamp can be divided into two groups, i.e. an in-phase group and an out-of-phase group. For an N lamp case, N/2 diodes are needed to form AND/OR gate for each group respectively. There are two sensed signals LIP and LIN. FIG. 11 shows a 4-lamp out-of-phase application with an AND gate in accordance with another embodiment of the present invention. Two extra diodes D1 and D2 are used as a half-wave rectifier. The RMS value of the signal also combines the RMS value of sensed signal LIP and LIN, which is used for lamp current regulation. Also, LIP and LIN are compared to a threshold by two separate comparators. Open lamp protection can be easily detected if the output pulse of any comparator is missing.

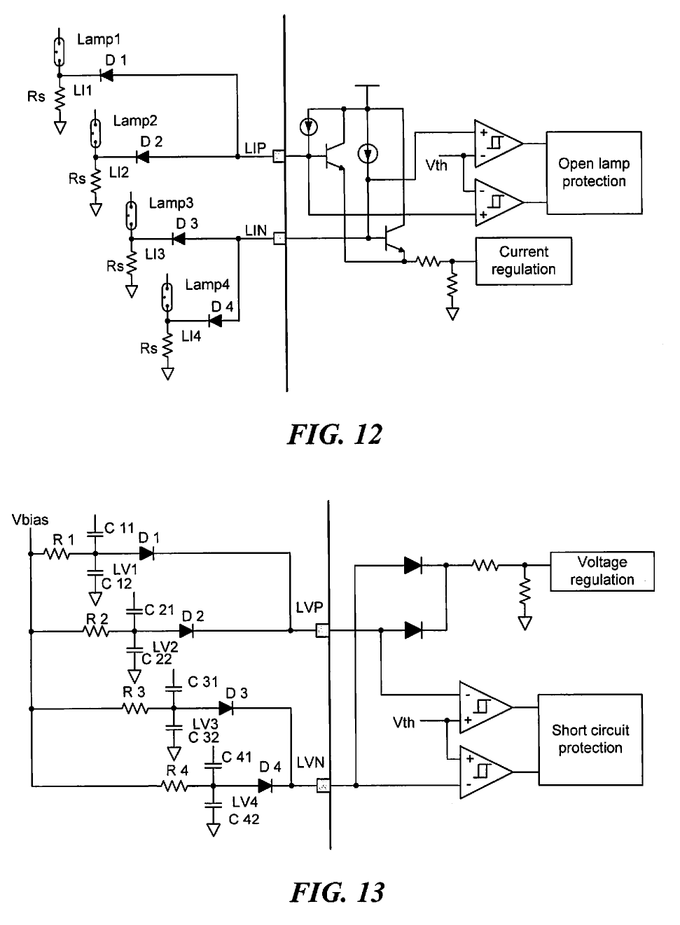

The proposed method can be implemented and integrated into an integrated circuit. FIG. 12 shows one possible implementation associated with an AND gate detector circuit suitable both for out-of-phase and in-phase applications. It also can easily expand to N lamp application by simply using N diodes. For out-of-phase application, the N lamps are divided into two groups according to their phase relationship. For in-phase application, the lamps can be equally divided into 2 groups due to the same phase relationship. FIG. 13 shows one of the implementation of the lamp voltage regulation and short circuit protection with an OR logic gate. Also, it is easy to extent to N lamp applications.

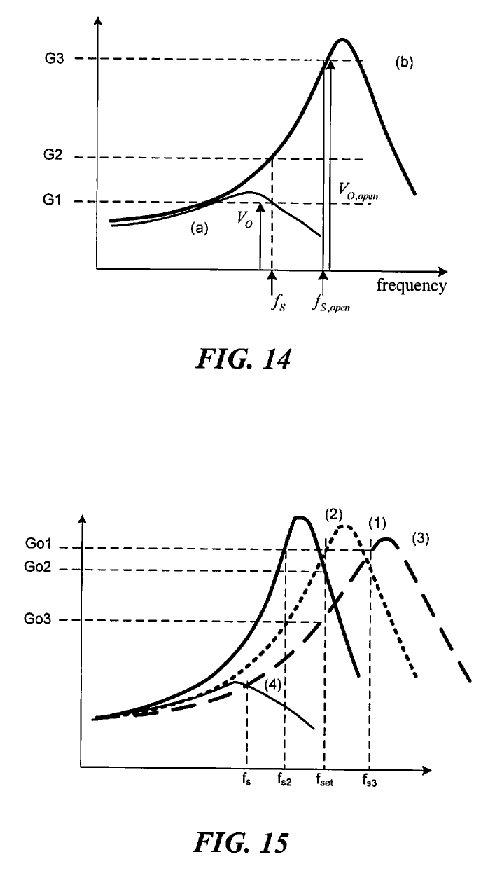

During startup or open lamp condition, a high voltage is usually required to ignite the lamp. The gain curve of the resonant circuit of CCFL inverter at normal condition and open lamp condition is shown in FIG. 14. At normal operation, the switching frequency is fs and the lamp voltage gain is G1. At open lamp condition, if the frequency keeps the same, the gain is G2. Generally, the open lamp voltage should be 2.5˜3 times larger than the normal lamp voltage. Therefore, the switching frequency at open lamp condition should increase to a higher value and the lamp voltage gain can be G3.

Generally, the open lamp voltage should be regulated to a certain value to avoid the risk of overstressing the transformer winding and other components. FIG. 15 shows three open lamp gain curves. Gain curve 1 represents the designed open lamp gain curve. The desired gain at open lamp condition is Go1 at designed open lamp switching frequency fset. Nevertheless, the transformer parasitic capacitance and load parasitic capacitance varies between different manufacturers. This significantly affects the gain curve. Furthermore, the resonant inductance and capacitance has a certain tolerance, such as 10% to 20%. With the effect of these parasitic parameters and parameters variation, the actual open lamp gain curve may be gain curve 2 or gain curve 3. Therefore, if the open lamp switching frequency is not adjusted properly, the lamp voltage gain will be lower than the desired one at a certain condition, such as Go2 and Go3 shown in FIG. 15.

Many conventional circuits can implement a frequency sweeping method by using the sensed signal such as LV. Generally, the sensed lamp voltage LV is compared to a reference with an amplifier. A compensation network such as PI is usually required to generate an error signal, which will be referred to as COMP signal hereafter. The COMP signal is used to control the duty cycle to regulate the lamp voltage. If the input voltage varies, the duty cycle also varies to regulate the lamp voltage. Also, if the parasitic parameters of the lamp, transformer, or resonant capacitor changes, the open lamp gain curve will also change. By using the duty cycle control signal COMP to adjust the open lamp frequency, a more flexible frequency sweeping method can be implemented.

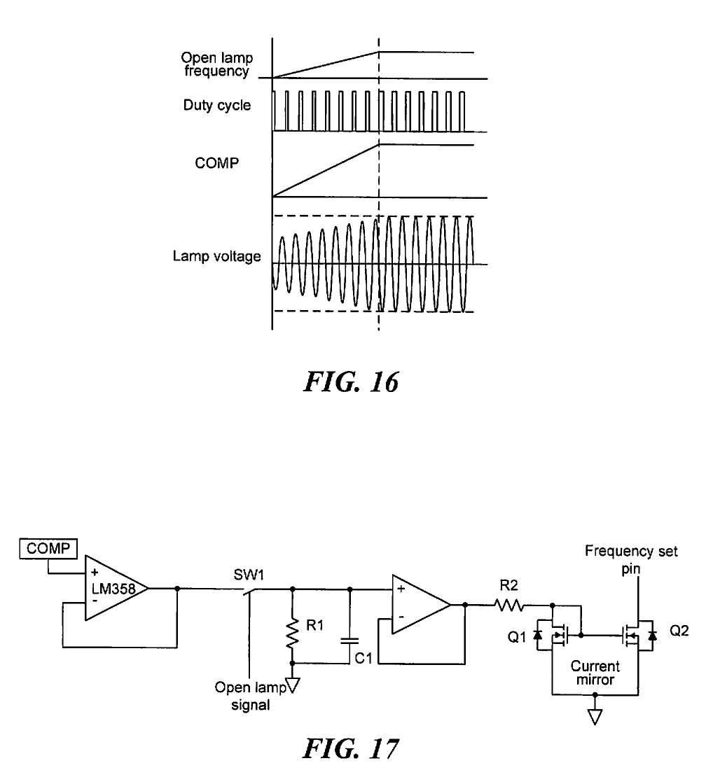

The startup waveform relating to the frequency sweeping method is shown in FIG. 16. At open lamp condition, the COMP will rise to get the desired open lamp voltage. The open lamp switching frequency will also rise from the normal operating frequency to a higher value according to the COMP voltage. As soon as lamp voltage reaches the desired value (i.e. desired lamp voltage gain), the COMP is regulated to keep the lamp voltage constant. Thus, the switching frequency and duty cycle is also fixed. As shown in FIG. 15, if the open lamp gain curve is changed to gain curve 2 or 3, the circuit can achieve the desired lamp voltage gain. The method offers a simple and reliable open lamp switching frequency setting method.

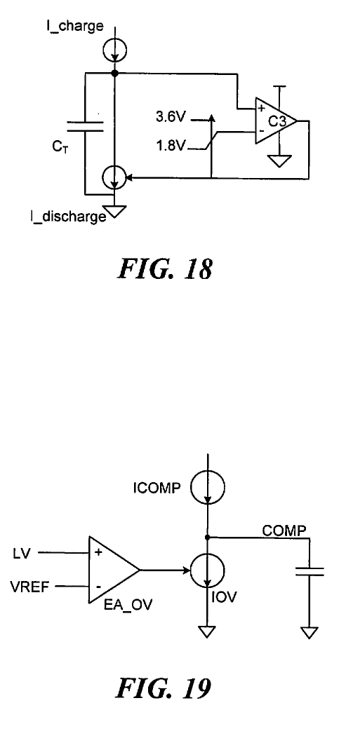

Generally, the normal switching frequency is controlled by a voltage to set the charge/discharge current of oscillator circuit, or control the VCO (Voltage Controlled Oscillator) to achieve the desired frequency. The COMP signal can be simply added to normal frequency set pin to adjust the switching frequency. FIG. 17 shows one of the implementations by adjusting the charge current of the normal frequency set pin as an example. The larger the current drawn from the frequency set pin, the higher the frequency is. As shown in FIG. 17, at open lamp condition, SW1 is conducting and COMP can pass through to adjust the frequency. At normal operation, the frequency is not affected by COMP. C1 and R1 can be integrated to realize slow frequency fold back as soon as open lamp signal is gone (i.e. lamp is ignited), which is useful to eliminate the possible current spike and voltage spike. Various implementation method is possible depend on the normal frequency setting method.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/we claim:

1. A method for detecting an open lamp condition in a discharge lamp system, comprising:
providing a DC bias voltage to a detector circuit that is coupled to at least one discharge lamp;
deriving a current signal from said detector circuit; and
if said current signal satisfies an open lamp condition, triggering an open lamp protection process.

2. The method in claim 1, further comprising: coupling said current signal to a pin on a controller of said discharge lamp system; and coupling said current signal to a protection trigger circuit on an integrated circuit level to trigger the open lamp protection process through said pin.

3. The method in claim 1, wherein said current signal is related to a maximum sensing current of said discharge lamp.

4. The method in claim 3, wherein said detector circuit is an OR gate detector circuit.

5. The method in claim 3, wherein the open lamp protection process is triggered when the lowest value of said current signal in one switching cycle is higher than a predetermined threshold voltage.

6. The method in claim 5, wherein said detector circuit is an AND gate detector circuit.

7. The method in claim 5, wherein the open lamp protection process is triggered when the highest value of said current signal in one switching cycle is lower than a threshold voltage.

8. A method for detecting an open lamp or a shorted lamp condition in a discharge lamp system, comprising:
providing a DC bias to a detector circuit that is coupled to a discharge lamp;
deriving a voltage signal from said detector circuit;
if said voltage signal satisfies an open lamp condition, triggering an open lamp protection process; and
if said voltage signal satisfies a shorted lamp condition, triggering a shorted lamp protection process.

9. The method in claim 8, further comprising: coupling said voltage signal to a pin on a controller of said discharge lamp system; and coupling said voltage signal to a protection trigger circuit on an integrated circuit level to trigger the open lamp protection process or the shorted lamp protection process through said pin.

10. The method in claim 8, wherein said voltage signal is related to a maximum sensing voltage of said discharge lamp.

11. The method in claim 10, wherein said detector circuit is an OR gate detector circuit.

12. The method in claim 10, wherein the open lamp protection process is triggered when the highest value of said voltage signal in one switching cycle is higher than a first predetermined threshold voltage, and the shorted lamp protection process is triggered when the lowest value of said voltage signal in one switching cycle is higher than a second predetermined threshold voltage.

13. The method in claim 8, wherein said voltage signal is related to a minimum sensing voltage of said discharge lamp.

14. The method in claim 13, wherein said detector circuit is an AND gate detector circuit.

15. The method in claim 13, wherein the open lamp protection process is triggered when the lowest value of said voltage signal in one switching cycle is lower than a first predetermined threshold voltage, and the shorted lamp protection process is triggered when the highest value of said voltage signal in one switching cycle is lower than a second predetermined threshold voltage.

16. A circuit capable of detecting an open lamp condition and triggering an open lamp process in a discharge lamp system, comprising:
a detector circuit coupled to at least one discharge lamp that outputs a current signal; and
a protection triggering circuit for receiving said current signal from said detector circuit and triggering the open lamp protection process if at least one lamp is open.

17. The circuit in claim 16, wherein said circuit is used in connection with a plurality of discharge lamps and said detector circuit is an OR gate detector circuit comprising:
a plurality of sensing resistors being coupled to said plurality of discharge lamps wherein one sensing resistor corresponds to one discharge lamp;
a plurality of diodes being coupled to said plurality of discharge lamps wherein one diode corresponds to one discharge lamp; and
a DC bias source, for providing the bias voltage, being coupled to said plurality of discharge lamps.

18. The circuit in claim 16, wherein said circuit is used in connection with a plurality of discharge lamps and said detector circuit is an AND gate detector circuit comprising:
a plurality of sensing resistors being coupled to said plurality of discharge lamps wherein one sensing resistor corresponds to one discharge lamp;
a plurality of diodes being coupled to said plurality of discharge lamps wherein one diode corresponds to one discharge lamp; and
a DC bias source, for providing the bias voltage, being coupled to said plurality of diodes through a pull-up resistor.

19. The circuit in claim 16, wherein said circuit is used in connection with a plurality of discharge lamps and said detector circuit comprising:
a first plurality of sensing resistors being coupled to a first plurality of discharge lamps wherein one sensing resistor corresponds to one discharge lamp and voltage of said first plurality of sensing resistors are in phase;
a first plurality of diodes being coupled to said first plurality of discharge lamps wherein one diode corresponds to one discharge lamp;
a first additional diode being coupled to said first plurality of diodes;
a second plurality of sensing resistors being coupled to a second plurality of discharge lamps wherein one sensing resistor corresponds to one discharge lamp and voltage of said second plurality of sensing resistors are 180 degree out-of-phase with said first plurality of sensing capacitors;
a second plurality of diodes being coupled to said second plurality of discharge lamps wherein one diodes corresponds to one discharge lamp;
a second additional diode being coupled to said second plurality of diodes; and
a DC bias source, for providing a bias voltage being coupled to said first plurality of diodes and said second plurality of diodes respectively.

20. A method for adjusting the switching frequency in a discharge lamp system, comprising:
deriving a voltage signal from a detecting circuit which is coupled to a discharge lamp or a plurality of discharge lamps;
comparing said voltage signal to a predetermined reference voltage and generating an error signal; and
adjusting the switching frequency according to said error signal.

21. The method in claim 20, wherein said voltage signal is related to a maximum sensing voltage of said discharge lamp or a plurality of discharge lamps.

22. The method in claim 20, wherein said voltage signal is related to a minimum sensing voltage of said discharge lamp or a plurality of discharge lamps.

23. The method in claim 20, further comprising adding said error signal to a frequency set pin on a controller of said discharge lamp system.

24. The method in claim 23, wherein said frequency set pin sets the charge and discharge current of an oscillator of said discharge lamp system.
